(19) United States
(12) Patent Application Publication
(10) Pub. No.: US 2009/0216587 A1
(43) Pub. Date: Aug. 27, 2009

(54) MAPPING OF PHYSICAL AND LOGICAL COORDINATES OF USERS WITH THAT OF THE NETWORK ELEMENTS

(76) Inventors: Saket Dwivedi, Tanda (IN); Harsha R. Angeri, Bangalore (IN); Vikram J. Arora, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/142,887

(22) Filed: Jun. 20, 2008

Related U.S. Application Data
(60) Provisional application No. 60/945,139, filed on Jun. 20, 2007.
(60) Provisional application No. 60/945,141, filed on Jun. 20, 2007.

(51) Int. Cl. G06Q 10/00; H04L 9/32; G06N 5/02; G01C 21/00

(52) U.S. Cl. 705/7; 726/5; 706/52; 701/300

(57) ABSTRACT

Physical coordinates of a user and an asset are determined. A probability that the user and the asset are close to one another is determined based on the physical coordinates of the user and the asset. Permission for the user to access to the asset is decided based on the probability. Additionally or alternatively, logical coordinates of a user and an asset are determined. The logical coordinates of the user and the asset are compared, and permission for the user to access to the asset is decided based on the comparison.

### RELATED APPLICATION

This application claims the benefit of U.S. Provisional Application No. 60/945,139, filed Jun. 20, 2007, and U.S. Provisional Application No. 60/945,141, filed Jun. 20, 2007, both of which are herein incorporated by reference in their entirety.

### TECHNICAL FIELD

The present disclosure relates to asset protection.

### BACKGROUND

Assets of organizations, and to some extent individuals, have shifted from being primarily physical based, i.e., goods, plants, machinery, paperwork, etc., to being data based, i.e., data files, video/voice information files, etc. This change in the asset base has blurred the perimeter of an organization so that assets, which were accessible only within the bricks and mortar of the organization or individual, are now accessible from outside the physical plant. Thus, whereas a CEO, for example, could once be assured that, by implementing appropriate perimeter protection safeguards, all critical assets (including data) of the company, which was stored as hard copies, could not be improperly accessed, compromised, and/or duplicated, today the CEO knows that it is much more difficult to protect sensitive information because it is stored in data files rather than in physical form.

Indeed, company personnel frequently leave company premises carrying with them critical information stored on their laptops. Also, hundreds of copies of critical information can easily be made by authorized employees, increasing the risk that critical information can be improperly accessed. Thus, individuals and organizations are increasingly faced with the problem of unauthorized access to their data storage devices such as computers (including laptops and desktops), PDAs, etc. Hence, it is imperative to ensure that sensitive information stored in data storage devices does not fall into unauthorized hands.

Several mechanisms have been instituted to protect unauthorized access to a company's information asset base. Organizations have strong physical security systems put in place to restrict physical access to both physical and network resources of the organization. Typically, a physical security system includes access control (e.g., using access cards/smart cards/biometrics for authentication). Access cards/smart cards are swiped through card readers present at doors, and cards can even be swiped at computers to gain network access. Only genuine card holders can, therefore, gain access to facilities. Organizations also employ other physical security systems such as video surveillance (e.g., using CCTV cameras to monitor access to at least restricted areas) and intrusion detection (e.g., for the protection of certain important zones).

Despite all of these security measures, incidents involving violations continue to occur. For example, a common intrusion practice is tailgating, in which an intruder simply follows an authorized person through a door and into a controlled space. Once inside the premises, it is not difficult to find an unlocked computer or even a locked computer with the password written nearby. Other practices such as password sharing, writing passwords in public places, leaving computers unlocked when leaving the workplace, frequent remote login (sometimes furthered by leaving the computer unattended), etc. create many loopholes allowing exploitation by an intruder.

Moreover, cards are transferable. For example, a card may be lost by an employee (it takes some time to report the loss of a card and disable it) or may be given away by an employee. The finder or recipient of the card can use it to gain access to an organization's physical and/or logical domains.

To ensure that only the most trustworthy people are recruited as employees, serious background checking procedures are used during recruitment. However, a significant number of data violations are performed by disgruntled and possibly terminated employees. Such employees often seek revenge against an organization for perceived wrongs, and want to cause some damage to the organization. A common method is to steal confidential information and share it with external parties. Further, employees can be gullible, and might be carrying sensitive information outside of the company premises that can be compromised. There have been instances of confidential customer information such as credit card numbers being stolen and sold by employees or by others. Hence, it is important to restrict access privileges, both in the physical domain and in the logical domain, particularly to terminated employees.

In addition, an intruder does not even need to be physically present in the organization to gain access to its information resources. As mentioned earlier, an intruder could gain physical access to a device that an authorized employee removes from the organization's premises. Given the sophistication of hacking mechanisms available today, it is widely believed that, if physical access to a computer can be obtained, unauthorized access to the organization's network is guaranteed. Alternatively, network attacks (e.g., IP spoofing, IP session hijacking) can be carried out over the Internet so as to steal information. Hence, organizations also have strong network security systems (firewalls, IDS, VPN, etc.) in place to restrict access to network resources of the organization.

Thus, a mechanism is required to ensure that only the genuine user gains access to a computer (desktop/laptop) both within and outside of the physical premises of the organization and that the genuine user gains access only to those resources on the network for which the user is authorized.

### BRIEF DESCRIPTION OF THE DRAWINGS

These and other features and advantages will become more apparent from the detailed description when taken in conjunction with the drawings in which:

FIG. 1 illustrates an architecture for a security system that can implement security measures as disclosed herein; and,

FIG. 2 is a first chart useful in explaining certain aspects of the present invention;

FIG. 3 is a second chart useful in explaining certain aspects of the present invention;

FIG. 4 illustrates a building layout useful in explaining certain aspects of the present invention;

FIGS. 5A, 5B, and 5B show an example of the construction of a logical coordinate;

FIG. 6 illustrates another building layout useful in explaining certain aspects of the present invention;

FIG. 7 is a table illustrating example walking speeds and probabilities associated with those walking speeds;

FIG. 8 illustrates a computer system as one example of an implementation of the security system of FIG. 1;

FIG. 9 is a flow chart an application that can be executed by the processor of FIG. 8 in order to execute certain aspects of the security system shown in FIG. 1;

FIG. 10 illustrates an example of a user array table contained in the identity database of FIG. 1.

### DETAILED DESCRIPTION

There are at least eight intrusion scenarios in which a physical security violation could enable an intruder to gain unauthorized access to a company's information such as that stored on a desktop PC, a laptop, a PDA, etc. These scenarios are listed in the following table.

| Scenario | | | | Scenario Security |
|---|---|---|---|---|
| # | Person | Office | Network | Problem |
| 1 | n | n | n | Physically accessing the |
| | | | | computer by breaking |
| | | | | into a house. |
| 2 | n | n | y | Physically accessing the |
| | | | | computer by breaking |
| | | | | into the house and |
| | | | | breaking into system. |
| 3 | n | y | n | Physically accessing the |
| | | | | computer and taking it |
| | | | | out of the office. |
| 4 | n | y | y | Remote login through the |
| | | | | firewall and taking |
| | | | | files. |
| 5 | y | n | n | Forcibly snatching the |
| | | | | computer from the |
| | | | | person. |
| 6 | y | n | y | Remote login through the |
| | | | | Internet and taking |
| | | | | files. |
| 7 | y | y | n | None. |
| 8 | y | y | y | Downloading an |
| | | | | application that removes |
| | | | | files. |

The first scenario, for example, covers a person who is an employee and who uses a company laptop which contains sensitive information, who is not present near the device, who is not in the office such as where the laptop is unattended at home, and who has not logged on to the network. An intruder who breaks into the employee's house can physically remove and/or access the laptop.

The final scenario, for example, covers a person who is working on his computer and who is logged on to the network in office. An intruder can, over the network, steal files stored on the computer.

All of these scenarios have one loophole. The computer does not “know” what is happening. The computer conventionally has only one way of verifying the user before granting complete access—a user password or smart card swipe, both of which are transferable credentials. Consequently, it is possible (and common) to access user data by impersonating the user. A solution is required to address this problem.

The main issue is that physical and logical authentication happens at different points in time. Hence, a series of events could lead to a compromise. However, if the physical and logical presence of any object (including a computer and/or a person) can be established at every instance of time when an access to the object is required, all of these scenarios can be solved. In other words, it must be confirmed that, every time a person logs onto a computer, the person is actually physically present at the computer. Once this confirmation happens, the detection of the event (e.g., login attempt) is enough to generate a suitable access revoke response whenever it is needed. Based on the mapping of both the physical and logical presence, an appropriate response can be provided.

The following possibilities relating to the above table may be considered. In the first intrusion scenario, if the computer “realizes” that it is not the actual owner who is physically carrying it away, it can revoke access to the intruder when the intruder tries to log on. Similarly, in the final scenario, if the computer “understands” that the actual user is logged in and is currently working on the system, the computer can check with the user by prompting the user to determine whether some files should be exported and thus protected against unauthorized data transfer.

If this approach is taken, it can be further realized that it is only necessary to detect the event and it is not necessary to determine whether the event is a physical event or a logical event. Extending this possibility even further, two (physical and logical) security solutions are unnecessary, only one is needed.

In view of the above, it is possible to solve the problems of the prior art by mapping physical and logical coordinates of every object. Physical coordinates identify the positions of objects (such as persons and/or inanimate objects) in the physical world. Logical coordinates uniquely identify the position of a logical object (such as a computer, a folder/file, a USB drive, a CD ROM, or any other element that stores/processes data in electronic form) in the logical world (i.e., the logical world—collection of all logical objects). Thus, the logical coordinate that identifies a desktop computer assigned to person A is different from the logical coordinate that identifies a desktop computer placed in the adjacent cubicle and assigned to person B. A logical coordinate, for example, may be some kind of unique identifier such that no two logical objects have the same identifier.

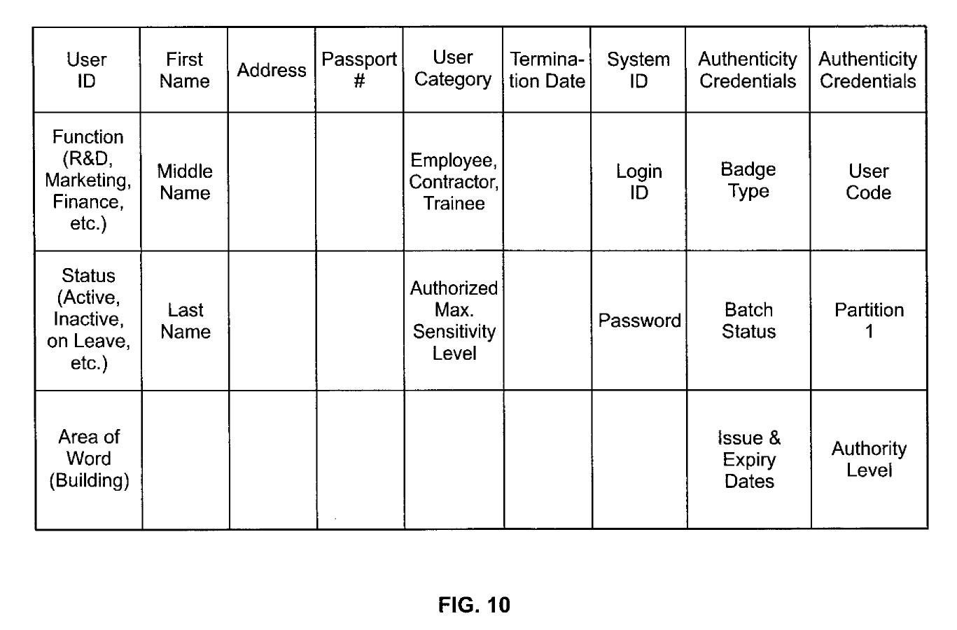

Logical coordinates may also serve to uniquely identify the interface between a person and an asset in the logical world. Passwords or smart cards are examples of this type of logical coordinate. The logical coordinate for this interface may or may not be differently constructed than a logical coordinate for a logical object. A person may possess different logical coordinates for different applications. For example, for remote access to a computer, the person may use a certain login/password (such as continuously generated with a satellite based security device). However, for normal access to a computer/access to a share area, the person may use a smart card. Nevertheless, the identity database contains a user array table which links all of these logical coordinates to this person as shown in FIG. 10.

In case of a satellite based security device, the corresponding login ID and password are continuously updated in the user table.

The mapping of physical and logical coordinates of every object with the person trying to gain access to the object would ensure that the object (e.g., laptop) “understands” the physical and logical location of the person and hence makes the appropriate decision. There are two possibilities: “mapping” of the physical and logical coordinates of a person with that of the object (logical asset) when an attempt to access the object is made; and, “authenticating” the user of the laptop using a mechanism that cannot be impersonated when an attempt to log on to the laptop is made.

Mapping could be done either by developing a layer which interfaces with both physical and logical security systems or by creating a unified security architecture with a common infrastructure for both realms.

Authenticating could be done by integrating a sensor mechanism into the computer to unambiguously authenticate the user. For example, authentication can be performed by a Webcam that uses face recognition software to ensure that the person logging in is an authorized user of the system. As another example, a thumb reading slot in the laptop can be used to ensure that the person using the laptop is authorized to do so.

Conventionally, developing a layer has been an incremental approach. Separate physical and network security vendors are required, and separate contracts for maintenance of the two systems need to be awarded. The conventional approach is not an enterprise risk approach. It would be prudent to instead develop a single system that oversees both physical and logical security. Such an approach is fundamentally different and unique.

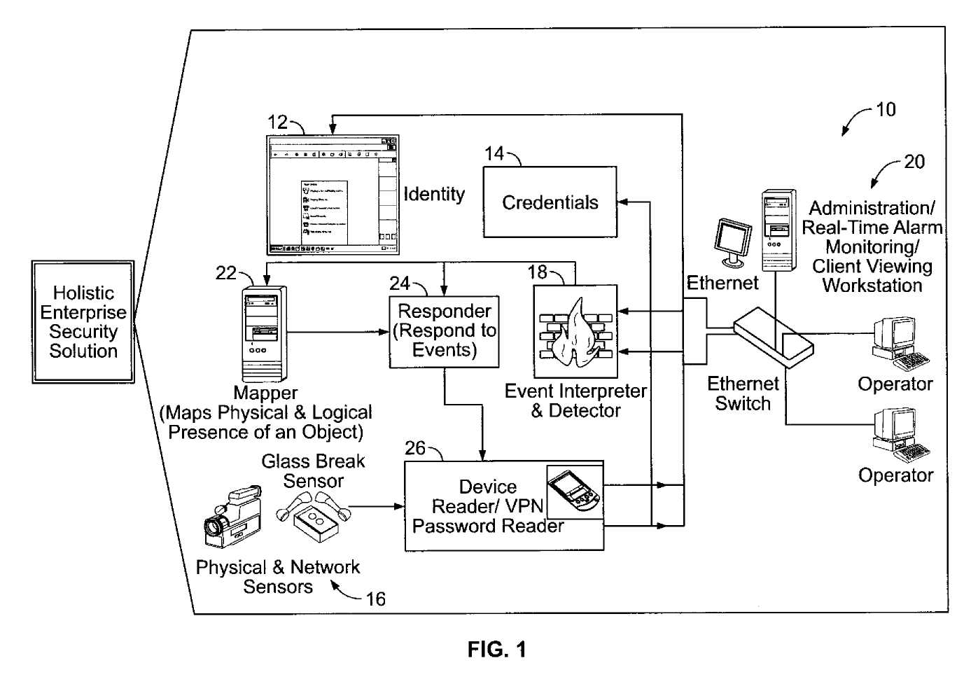

FIG. 1 shows an architecture of a security system 10 that is fundamentally different from the current solutions. The security system 10 includes an identity database 12 that stores the details of all people in the enterprise including, for example, officers, employees, visitors, contractors, regulators, etc. The details stored in the Identity database include, for example, designation, gender, place of work, current status (e.g., employee serving notice period, contractor being terminated soon), etc.

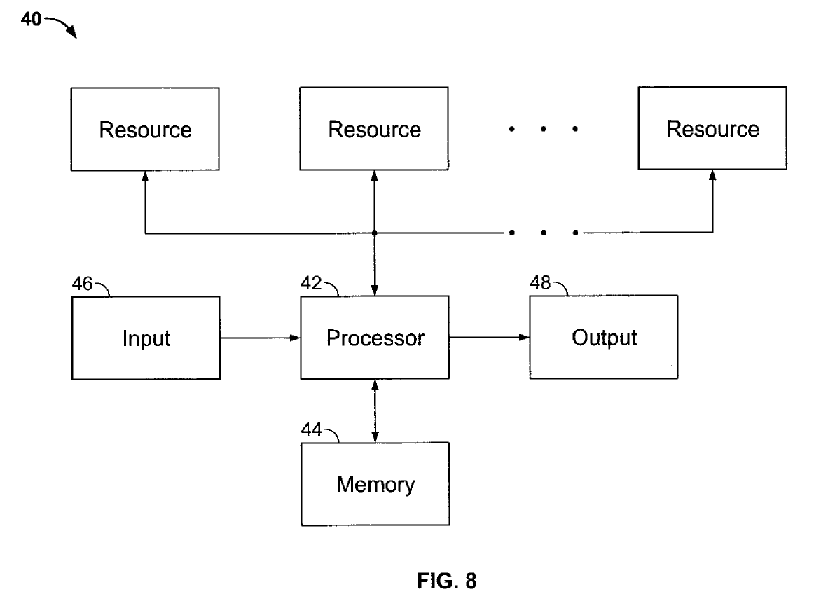

The security system 10 also includes a credentials management engine 14, which is a graphic tool that can be used to set the privileges for access to the physical facilities and computer networks of an enterprise independent of each other. The privileges of persons can be changed from time to time. For example, the credentials management engine 14 can be used to revoke the privileges of employees who have resigned, to grant access to the server room to certain employees who did not have such privilege earlier, etc. Thus, the credentials management engine 14 defines the privileges of each person authorized to assets of an enterprise. These privileges are stored in the user array table illustrated by way of example in FIG. 10. Any changes made in the privileges of a user (including granting and revoking of privileges) or any addition/deletion of users can be attributed to the person (such as the administrator) who made the changes. A log of such changes is kept in a privilege archive file in the memory 44 shown in FIG. 8, which illustrates a possible implementation of the system. This privilege archive file can be reviewed for forensic and audit purposes.

A cluster of physical and network sensors 16, which include, for example, card readers, password readers, biometric sensors, and/or the like, provides information about events to the event interpreter and detector for analysis and appropriate action. These sensors 16 also help establish the physical and logical presence of objects.

An event interpreter and detector 18 accepts inputs from the sensors 16 including readers such as access control card readers to perform real time situational awareness. In conjunction with the credentials management engine 14, the event interpreter and detector 18 understands the events going on. Network security elements such as a firewall and IDS also interface with and provide events taking place in the logical world, such as a virus attack. The event interpreter and detector 18 sends real time alarms to an alarm monitoring/client viewing workstation 20 so that security guards possess real time situational awareness and can take corrective action if required.

A mapper 22 is a layer which tries to correlate the logical coordinate of an event with its physical coordinate. Based on whether the coordinates match, the mapper 22 sends an appropriate message to a responder.

A responder 24 is the actual controller that actuates the response mechanism (e.g., grant/revoke access) based on the inputs that it receives from the mapper 22.

The security system 10 includes device readers/VPN password readers 26. Device readers, for example, are access card readers, biometric thumb readers/face recognition cameras, etc. Password readers, for example, are basically domain controllers or any other entities which validate the password entered by a user to gain access.

The functioning of the constituents of the security system 10 remains the same though the relative positions of the constituents can change (for example, the mapper 22 and the responder 24 can reside on the same hardware, the identity database 12 and the credentials management engine 14 can be merged, etc.).

The architecture of the security system 10 is different from those known in the prior art in many respects. For example, the mapper 22 in the architecture of FIG. 1 uses both physical and logical coordinates of an event in order to facilitate a decision on the granting and/or revoking of access.

Interfacing logical and physical security elements with the same operating system on the same server is unique.

The real time situational awareness of the architecture of FIG. 1 is unique. For example, a user's computer may be left unattended. The event interpreter and detector 18 can understand this event by detecting a swipe of the user's card at an exit door indicating that the user has gone outside of the room containing the computer or has gone beyond a certain range of the computer [for example, the Mapper 22 signals the result of mapping the user with the computer to be “false” as soon as the user swipes out]. In this case, the responder 24 may lock the laptop.

Certain messaging alerts may be unique. For example, supervisors and/or security personnel may receive a message by e-mail, mobile phone, or otherwise, that a breach has occurred.

This architecture solves the problems associated with the eight scenarios described above. In scenario 1, an employee to whom a company laptop is assigned leaves it unattended at some place other than the office and is not logged on to the network. The computer may or may not be unlocked. An unscrupulous person takes advantage and carries the laptop away. That person, if needed, tries to open and log on to the laptop, perhaps using the password previously obtained from the employee. That person could even log on to the company network over the internet.

Even if the company issues smart cards and/or biometric readers, this situation cannot be avoided. If the computer was unlocked, the intruder has ready access. If not, passwords can be hacked. Indeed, devices are available which, when attached to the keyboard, can hack passwords, and password cracking software exists.

Smart Cards/Biometrics have been used for facilities access at the office. If a user has a desktop computer in the office, no intruder can gain physical access to it unless the intruder enters the office. In that situation, Smart Card/Biometrics can solve the problem, at least in part. Users who possess laptops present different problems. Since the user may take the laptop out of office, there is no need to use a facility access credential to gain access to the laptop. Only a password is needed. Although Smart Cards and Biometrics are also used with in connection with a laptop, most laptops in use today use just passwords. Moreover, even if Smart Cards were used for laptop access, the point remains that Smart Cards are transferable and can be misused. For example, it is common to leave a Smart Card near a laptop or to keep it in the same bag which carries the laptop. In fact, when a user leaves his terminal while in office, say for a coffee break, it is common practice for the user to forget and leave the Smart Card in the slot itself, creating a potential breach opportunity. Usage of Biometrics, as proposed to the solution for logging on to the laptop, of course, solves the problem. But the point remains that biometric technology is expensive and generally not feasible to be used for low end data storage/processing devices. Also, once a biometric authentication has been made, maybe using a thumb reader, if the computer is left unlocked and the user moves away, it still presents an opportunity for an intruder to gain unauthorized access.

Using the architecture of FIG. 1, the laptop checks for the biometric identity of the person who tries to gain access (thumb impression or face reading) and establishes that the person trying to log in is not the genuine user. It is possible that the employee permits some other genuine user (the employee's assistant, for example) to use the laptop. The laptops' webcam or thumb reader, which may be one of the sensors 16, compares the input to the database of all the genuine users. If none of it matches, it revokes access. Beyond this, the laptop can be configured to take other actions. For example, if the genuine user does not log in within 48 hours of a person trying to log on without the correct biometric identity, the laptop irretrievably deletes all the information stored. In the solution disclosed herein, whenever the genuine user moves more than a certain distance away from the computer, the computer auto locks—this can be done using, say, RFID tags. So, if the computer was unlocked initially, it would be locked once the user moves out.

In case the intruder tries to log on to the corporate network, however, and on verifying that the intruder is not a genuine user, the mapper 22 allows a very short term access to the network (such as ten seconds) during which a message such as an e-mail is sent to the employee, the IP address from which login attempt is being made is identified, and access is thereafter suspended and the computer is locked.

In scenario 2, an employee to whom a company laptop is assigned leaves the laptop unattended at home while the laptop is logged on to the corporate network. An intruder takes advantage and tries to hack into the company's systems.

If the laptop has a webcam as one of its sensors 16, as soon as the employee leaves the laptop and moves out of the field of view of the webcam, the laptop immediately locks itself, so physical usage of laptop by someone else is ruled out.

In the proposed architecture, the laptop checks for the biometric identity of the person who tries to gain access using, for example, a thumb impression or a face reading, and establishes that the biometric identity does not match with any of the genuine users. In this case, access is revoked. Being on the network, it also sends the alarm/SMS (Short Message Service) to the stakeholders.

In scenario 3, an employee to whom a company laptop is assigned leaves the laptop unattended at the office but not logged on to the network. An intruder takes advantage and tries to log on to the computer to steal the data stored inside.

As soon as the employee leaves the laptop and moves out of the field of view of the webcam, the laptop immediately locks itself.

If the intruder has entered the room by tailgating, then the intruder does not have a valid physical coordinate and, hence, the mapper 22 cannot obtain a correct mapping of the coordinates. If the intruder belongs to the same area as the genuine user, even then since the genuine user has swiped out, the coordinate mapping is not true. This is explained more fully in the discussion for scenario 4 below. Finally, even if the user has not swiped out of the area, using a RFID, the computer could detect the fact that the user is not close by and, hence, an audible alarm could be generated to address this case.

In a first possibility of scenario 4, a person tailgates a person into a room, finds an unattended computer, which is common in most companies, and begins stealing information.

Even if the company issues smart cards and/or biometric readers, it is not possible to avoid this situation.

In the architecture of FIG. 1, the event interpreter and detector 18 understands that the genuine user who would have swiped his credential while entering the facility possesses a valid physical coordinate. After having left the particular room, the physical coordinate of the genuine user could be, for example, “Inside Main Campus|Building A∥3rd floor∥room #4”—which is different from the room in which the computer is present—the latter could be room #3 on the 3^{rd} floor. Alternatively, if the genuine user is out of the office, his physical coordinate could instead simply be, for example, “Outside Office” because that may be sufficient to serve the purpose. The tailgater, however, has not swiped valid credentials when entering the facility and, therefore, has not established a physical coordinate. When the tailgater tries to access the network (it is assumed that the tailgater is using the password, i.e., logical coordinate, of the genuine user) through a localized port, the event interpreter and detector 18 records the logical coordinate and sends to the mapper 22. The two coordinates do not match, such as where the genuine user has left the facility swiping his card on the way out or swiping his card elsewhere, while the physical coordinate of the network port which the particular computer is connected to is different from the aforementioned genuine user's physical coordinate. (A computer would acquire the same physical coordinate as the network port it is connected to.) The responder 24 hence revokes the access of the tailgater and generates alarm. Also, as soon as the genuine user leaves the facility, the laptop of the genuine user automatically locks. This happens because coordinate mapping is continuous and happens in real time. A mapping result which was “true” changes to “false” as soon as any one of the coordinate changes alone. If the tailgater tries to access the network using his own credentials using logical coordinates different from that of the genuine user, the event interpreter and detector 18 detects that the tailgater does not possess a matching logical coordinate (with that of the computer) nor does he possess a valid physical coordinate, so access is revoked and an alarm is generated.

In a second possibility of scenario 4, a person breaks into a room, such as at night, to steal information from unattended workstations.

Even if the company issues smart cards and/or biometric readers, it is not possible to avoid this situation.

In the architecture of FIG. 1, the event interpreter and detector 18 understands that an unauthorized event has happened (e.g., a glass break sensor detects breakage of glass), and bypasses the mapper 22 to inform the responder 24 to lock all computers.

In a third possibility of scenario 4, an employee enters the office, logs on to the corporate network, and leaves the office for a cup of coffee. An intruder remotely logs in through the firewall and tries to take out files.

As soon as the employee leaves the laptop and moves out of the field of view of the webcam, the laptop immediately locks itself, so physical usage of laptop by someone else is ruled out. It may be noted that the mention of a webcam herein is illustrative and any other sensing mechanism like an RFID system could be used instead of or in addition to a webcam.

In the architecture of FIG. 1, the mapper 22 understands that the employee is in office and has logged in from the office. Next, the mapper 22 calls the list of all other genuine users of this computer (such as the employee's secretary, etc.) and maps their locations. Since the intruder cannot provide a valid physical coordinate (such as “Out of office” for another genuine user who is probably traveling), the mapping would be evaluated as “false” and access revoked. On the other hand, if another genuine user is logging on remotely, that genuine user is granted access after being prompting for a separate remote login password.

All other genuine users may have restricted access to the files.

If the employee himself, in this scenario, tries to log on remotely to his laptop (for example, he needs some files from a conference room), then the mapper 22 maps his coordinates again but this time in the conference room and, based on these new coordinates, grants access.

In scenario 5, an employee leaves work for home and on the way somebody picks up the laptop from his car and walks away with it.

This scenario will be dealt with similarly to scenario 1.

In both scenarios 1 and 5, the laptop is essentially stolen. A mechanism similar that on mobile phones can be used such that, whenever a successful attempt to log on to the network is made, instructions are sent to the laptop to deactivate itself permanently. A software application could be installed into the laptop which deletes all the content once such instructions are received.

In scenario 6, an employee is working from home and is logged on to the network. An intruder tries to access remotely.

This scenario will be dealt with similarly to scenario 1.

In scenario 7, an employee is working in office on the laptop without logging on to the network, which is probably the safest mode of working and does not require any security measure.

The webcam continuously monitors the working employee and if the employee moves out of the field of view, the laptops locks.

In scenario 8, an employee is working on his laptop logged on to the network in the office, and an intruder tries to, over the network, steal the files stored on the computer.

The mapper 22 immediately revokes access to the remote user as the employee is working and his physical coordinates do not match the logical coordinates of the remote access (for example, the remote access password is assumed to be different from that of a normal log on; since a normal log on password is already in use, the event interpreter and detector 18 understands that the genuine user is logged on). It is possible that another genuine user is trying to log in, so the event interpreter and detector 18 may prompt the employee about whether to grant access to the other user. The exact response of the system may depend on the policies set by the administrator—this aspect is discussed below.

In this manner, the architecture of FIG. 1 and the enhancements built into the machines (e.g., webcam with video analytics, etc.) can safeguard valuable company information from all possible threat scenarios.

The security system 10 described herein grants only the genuine user access to a network resource such as a computer by ensuring that only the user who has physically entered a particular part of a facility in which the network resource is located or is brought inside in a genuine manner is allowed to gain access to the network resource present there. The identity of the user also needs to be verified continuously.

The mapper 22 shown in FIG. 1 and described above is a layer which correlates the physical and logical coordinates of the user with the physical and logical coordinates of the network resource whenever an event occurs. Unique physical and logical coordinates are assigned to each processing device (laptop, desktop, PDA, other network assets, etc.) in all of the organizations facilities.

As an example, currently a Globally Unique Identifier or GUID (Globally Unique Identifier; a pseudo-randomly generated number) is produced by the Windows OS or by some Windows applications. Windows identifies user accounts by a username (computer/domain and username) and assigns it a GUID. While each generated GUID is not guaranteed to be unique, the total number of unique keys is so large that the probability of the same number being generated twice is very small.

The same or similar logical coordinate, which is unique and non-superimposable (the coordinate of an object in the logical space is like the fingerprint of a human being; it cannot be assigned to another object in the logical space) preferably should be used. Since GUIDs can also be used to identify applications, files, database entries, etc., any restricted network assets (such as shared resources to which only a few employees need to have access or confidential customer data) can also be provided with GUIDs.

The mapper 22 then is arranged to map the coordinates of the person trying to access such files to the coordinates of the files in order to grant/revoke access. Thus, access to restricted files can be granted only to genuine users.

Alternatively, instead of using GUIDs, a logical coordinate more accurate (and absolutely unique) than the GUID can be used.

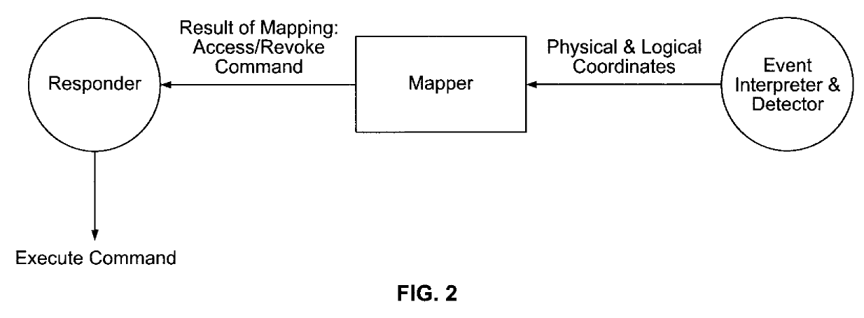

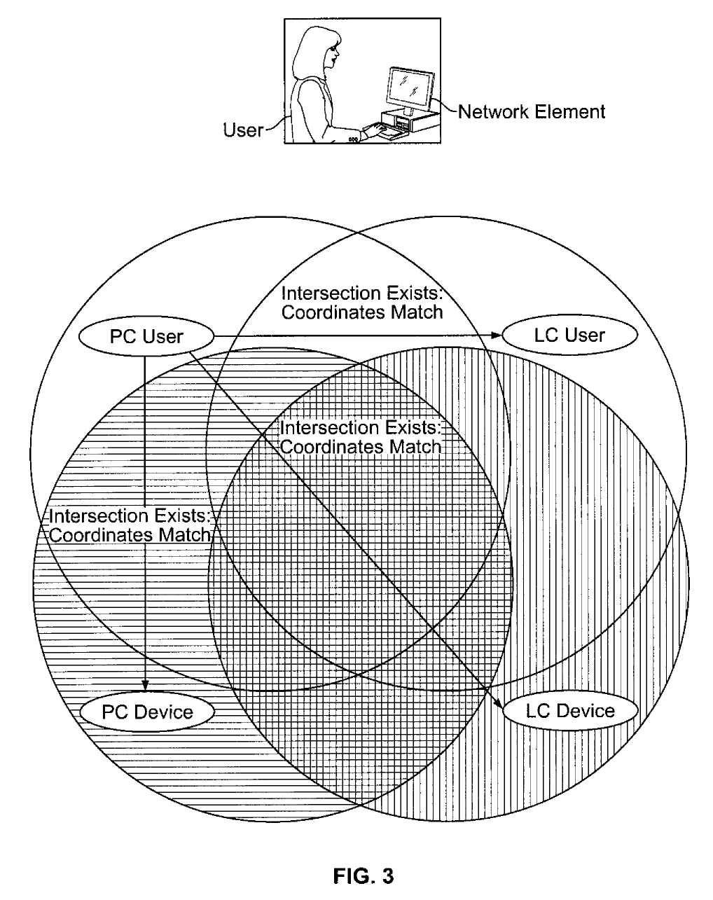

As shown in FIG. 2, the event interpreter and detector 18 sends the physical and logical coordinates of the user and the network resource to the mapper 22. As shown in FIGS. 2 and 3, the mapper 22 maps the physical coordinate of the user to the physical coordinate of the network element, and maps the logical coordinate of the user to the logical coordinate of the network element. (The network element could be any data storing device or processing device or could even be a file or folder or application such as Microsoft outlook, depending on the context.)

Accordingly, the mapper 22 understands the geography of the enterprise, i.e., the locations of processing devices such as computers and servers in rooms and how those rooms can be accessed. It even understands the positions of various network ports/hubs. Whenever an attempt to log on to a network asset is made, the mapper 22 retrieves the physical coordinate of the user (maybe in real time, in which case the mapper 22 already has the physical coordinate in advance—this is done since the one of the device readers 26 in FIG. 1—the access card reader at the door provides the same to the mapper 22 when the user swipes his card), and checks whether the physical coordinate of the user matches the physical coordinate of the processing device (thus ensuring that the asset is present where it is supposed to be). The mapper 22 also checks whether the logical coordinate of the user matches that of the processing device. The user is granted access to the processing device only in the case of a dual match.

This concept can be extended further to more devices so that a check can be made to determine that all of the other coordinates also match, whereby several other facts can be verified. For example, by matching the physical coordinates of the user with the logical coordinates of the processing device, it can be verified that the user has brought the right processing device into the right office. The mapper 22 basically ensures that only the genuine user who is present in the room has gained access to the processing device.

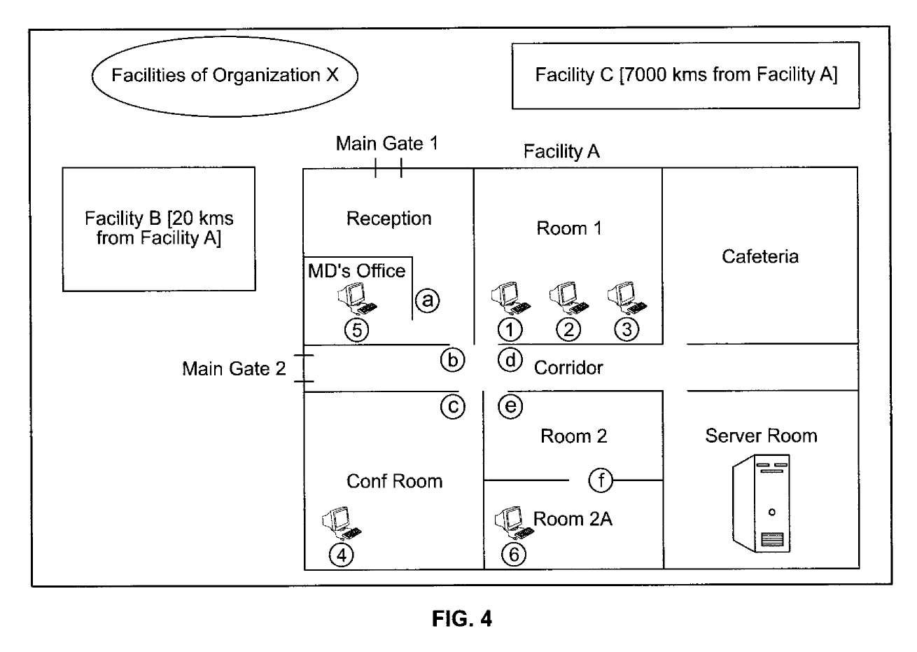

Some examples are given with respect to FIG. 4.

A geographic check can be made. The mapper 22 understands that Room 2A comes after Room 2 such that a person can only enter Room 2A after having entered Room 2. This room arrangement means that a genuine user of logical coordinate 6 (which may be a networked desktop computer or a network port where the user can plug in a laptop) has swiped the user's access card at Main Gate 1, if applicable, then at door B, then at door E, and then finally at door F. Alternatively, the user has swiped the user's access card at Main Gate 2, if applicable, then at door E, then finally at door F. If the user does not swipe his card in this manner, the mapper 22 evaluates non matching physical coordinates and revokes the access.

A timeline check can be made. Facility A is 20 kms from facility B. If a person leaves facility A at 5 PM (the user swipes the user's access card outwards at one of the exits doors or at the main gate, if applicable, and then tries to gain remote access to a resource within facility A from facility B at 5 minutes past 5 PM, the mapper 22 at facility A considers the fact that an employee who left 5 minutes back cannot possibly be logging in through remote access through facility B and revokes access. Such a feature would address the common problem of forged/duplicate access cards.

A duplication check can be made. If a user is present at facility A working in his or her assigned cubicle and a remote login attempt into the network is made using this user's credentials, the mapper 22 again considers that the user is present within the facility (the user's logical coordinate, the password, is in use), and determines that the user cannot possibly be logging in from outside the facility. The mapper 22 verifies that the user is working within the facility using the user's logical coordinate (to ensure that the user is actually working in the facility) and if so, the mapper 22 revokes access for the remote attempt.

Also, facility C may be in another country. Therefore, a user cannot simultaneously gain physical access to both facilities A and C simultaneously. If a first employee of facility A travels to facility C on official work (the first employee swipes the appropriate card at facility C) and, during the absence of the first employee from facility A, a second employee tries to gain access to the desktop/shared network resource of the first employee using the first employee's password, the mapper 22 again observes the discrepancy and revokes access.

Alternatively, the mapper 22 could be configured by the user/by the administrator on request by the user in such a manner that, as long as an “Out of office Auto reply” is activated by a user, all of the user's resources are blocked except for the user's remote login till the user returns back and deactivates the Auto reply.

The following scenario may be considered for an understanding of the effectiveness of the mapper 22. If a first employee tries to use the password of a second employee to log on to the second employee's computer (assuming that no multiple users are allowed), the mapper 22 maps the physical coordinate of the second employee with the physical coordinate of the computer. If the actual user, i.e., the first employee, has a different physical coordinate such as where the actual user has gone out of room in which the processing device is located, the mapper 22 of course revokes access. In the case where the physical coordinate of the actual user is the same as the second employee, the mapper 22 then maps the physical coordinate of the actual user with the logical coordinate of the second employee by verifying the identity of the actual user. In this case, the actual user (i.e., the intruder) cannot establish that he or she is physically the same person who owns the password. Hence, the mapper 22 understands that an intruder is using the password and access would not be granted.

Although the architecture of FIG. 1 shows the use of only one mapper 22 for the organization to map the respective coordinates for all access attempts (centralized control) at the organizational level, the mapping function could instead distributed among plural devices. For example, one or more processing devices may contain the mapping function. Thus, a processing device could itself determine its physical coordinate using GPS and assign the same to the user. The logical coordinate of the user, which could be the user's password, would be just used to check the user identity. This latter concept is more useful for smaller processing devices.

If an intruder steals a processing device and tries to access the data stored on his own computer, the processing device can use the mapper 22 to verify the identity of the intruder, maybe using the physical coordinate from the computer's mapper 22.

A processing device, for example, could be a server, a desktop processor, a laptop, a storage device such as a thumb drive, a hard disk drive, etc. In the case where the processing device is a storage device, organizational data can be stored in several forms on this storage device. The intent is to prevent this data being stolen by an intruder.

If an intruder steals a thumb drive, for example, where the thumb drive contains important data, if the intruder tries to access this important data using computer such as a public computer or the intruder's personal computer, and if the thumb drive is GPS enabled, the thumb drive can determine its physical coordinate using GPS and also can assign the same physical coordinate to the intruder. Then, the thumb drive can be arranged to prompt the intruder to supply the intruder's logical coordinate such as a password or a biometric input and to use its mapping function to map the physical coordinate and the logical coordinate. Since these two coordinates will not match, the thumb drive could revoke access to the data. If the thumb drive does not have a mapping function, it can use the mapper 22 of the computer being used by the intruder to perform the mapping.

Thus, the architecture disclosed herein ensures that only genuine users gain access to an asset both inside and outside the physical premises of an organization, thereby providing effective security. A pair of coordinates is assigned to each user and to each valuable asset of an organization. This coordinate system is used to enforce security in an organization. A physical coordinate is assigned to each user and to each valuable asset. The physical coordinate uniquely identifies the physical/geographical position of the user and the asset, respectively, within an organization or recognizes that the user is outside the premises of an organization. A logical coordinate is also assigned to each user and to each valuable asset. The logical coordinate defines unique credentials for logical access to the user and defines a unique identifier for the asset. These coordinates are used to restrict unauthorized access to assets by users, thus aiding in enterprise security management.

In order to define the coordinate system, it is assumed that a list of all users and all assets of an enterprise are available. These lists can be stored in the identity database of FIG. 1. A pair of coordinates is assigned to each user and to each asset of an enterprise. There coordinates may be part of the user and asset lists. The first element of a pair is a physical coordinate, and the second element of the pair is a logical coordinate. Each of these elements is preferably unique such that no two different users and no two different assets have the same pair of coordinates. The description here is given for the purpose of illustration. It would be apparent to those skilled in the art that the implementation would differ for different applications and various forms of implementations may have to be grouped together to construct the complete solution for the enterprise. For example, several files on the computer of each employee would be considered valuable assets. In that case, the identity database 12 has to be decentralized for every computer and mechanisms must be created such that these decentralized components interact with the centralized component.

A physical coordinate is an entity or identifier that uniquely identifies the physical location of a user or asset within an enterprise. Alternately, it also identifies that a particular user or asset is outside the premises of the enterprise. It is assumed that the following detailed information regarding all the facilities/buildings of the concerned enterprise is available: a list of all facilities/buildings of the enterprise; a list of all the rooms/enclosures of each facility of the enterprise; a list of all groupings amongst the rooms/enclosures/facilities (these groupings partition a facility into zones and can be used for specifying particular security policies for the zone; in other words, a zone is a set of rooms/enclosed spaces in one or more facilities of an enterprise); a list of all doors, cubicles, partitions inside each room; a list of doors shared by two or more rooms; a list of network connection points within each room in each facility of the enterprise, etc.

With the above information, an example of a physical coordinate of a user is provided by the following table:

Physical Coordinate (user-ID/asset-ID)

| | |
|---|---|
| Facility Identifier | — |
| Zone Identifier | — |
| Room Identifier | — |

The first row in the above table indicates that the table represents the physical coordinate of a user or of an asset with a particular unique identifier (denoted by user-id or asset-id respectively). Whenever a new user or new [valuable] asset is brought into the system, such a unique ID is assigned to the user/asset. The next three rows define the facility identifier, the zone identifier, and the room identifier, respectively. The second column in the second, third and fourth rows in the above table are filled in with the actual data corresponding to the respective identifier.

The facility identifier, the zone identifier, and the room identifier of any user or asset are dynamic in nature and change as the user or asset moves through the enterprise. In case of a user, for example, who moves from Room #4 on the 3^{rd} floor inside Building A to Room #3 on the 2^{nd} floor in adjacent Building B, the physical coordinate of the user would change from “Inside Main Campus|Building A∥3rd floor∥room #4” to “Inside Main Campus|Building B∥2nd floor∥room #3”. In tabular form, this change can be represented by the two tables immediately below.

Before Moving
Physical Coordinate (user ID/asset ID)

| | |
|---|---|
| Facility Identifier | Inside Main Campus |
| Zone Identifier | Building A |
| Room Identifier | 3^{rd} Floor - Room #4 |

After Moving
Physical Coordinate (user ID/asset ID)

| | |
|---|---|
| Facility Identifier | Inside Main Campus |
| Zone Identifier | Building B |
| Room Identifier | 2^{nd} Floor - Room 3 |

As can be seen, two of the three identifiers have changed due to the movement. The above tabular representation is illustrative only. The level of granularity (which represents the accuracy or resolution of how the physical coordinate is defined) could be higher, and hence the table could have more than three rows—more identifiers; for example, one measuring the exact cubicle where the user is present could be added.

In case of assets, the above discussion holds good only partially. Whereas the physical coordinates of assets is also subject to change, for example, when laptops or thumb drives are moved from one room to another, certain identifiers could be fixed for certain assets. For example, for network ports/hubs, all three identifiers could be fixed (made static) so that any device connected to the network ports/hubs could be assigned a fixed physical coordinate (same as that of the network port/hub). Once a laptop connected to a certain network port A is disconnected and moved to another room and connected to another network port B, its physical coordinate also changes from being identical to the physical coordinate of network port A to that of network port B. IS administrators would have to manually alter the physical coordinates of hubs as they are moved from one physical location to another, if need be.

In case a particular user is outside the enterprise, the facility identifier field may be filled by a designated identifier indicating the same.

By the above definition of physical coordinate, it is clear that each user's physical coordinate will identify the physical location of the user within an enterprise.

It is assumed that the physical coordinates of each user and each asset in an enterprise can be defined. Data from any of the existing physical access control systems can be used to define physical coordinates of a user as the user is moving around in a facility. As far as physical coordinates of certain assets are concerned, the facility/security administrator of an enterprise can be provided with a menu that can be used to define the parameters of the physical coordinate of the particular asset. Any request for movement of the asset within/outside an enterprise would first initiate a compulsory modification in such a menu, thereby ensuring that the physical coordinates are appropriately modified with each change of location of the asset. In this case, it is assumed that the assets being considered are those which have significant value for the organization and are generally immobile—for example heavy laboratory equipments. For assets such as laptops, the physical coordinate is determined by the network port they are connected to. For assets such as thumb drives, the physical coordinate is determined by the computers they are connected to, the physical coordinate of which in turn is determined by the network ports they are connected to.

A logical coordinate is an entity or identifier that defines an unique mechanism that can be used by users and assets as follows: logical coordinates of a user act as unique credentials for the user to gain access to various information assets; and, logical coordinates of an information asset uniquely identify the asset and this can be used to decide on providing access grants to requests by users.

A logical coordinate of a user, for example, may be nothing more than the user's system network identifier (login-id) and the password provided to each user. For example, this logical coordinate might include a system-wide user-id and a password that are provided to each user of the enterprise system to login to various logical resources and onto the network. Logical coordinates for users are usually defined by system administrators and do change throughout the period during which the user is employed in an enterprise, for example organizations may require their employees to change their passwords every 30 days. Alternatively, the logical coordinate could be any other credential attributable to the person—such as his/her biometric credentials.

A logical coordinate of an information asset, for example, is any identifier that assigns a unique identifier label to various information assets. Information assets include computers, files, applications, folders, printers, thumb drives, etc. As discussed above, a GUID can be used as a logical coordinate. Such coordinates are kept static throughout the life of the information asset or are changed at intervals indicating appropriate changes in the status of the asset.

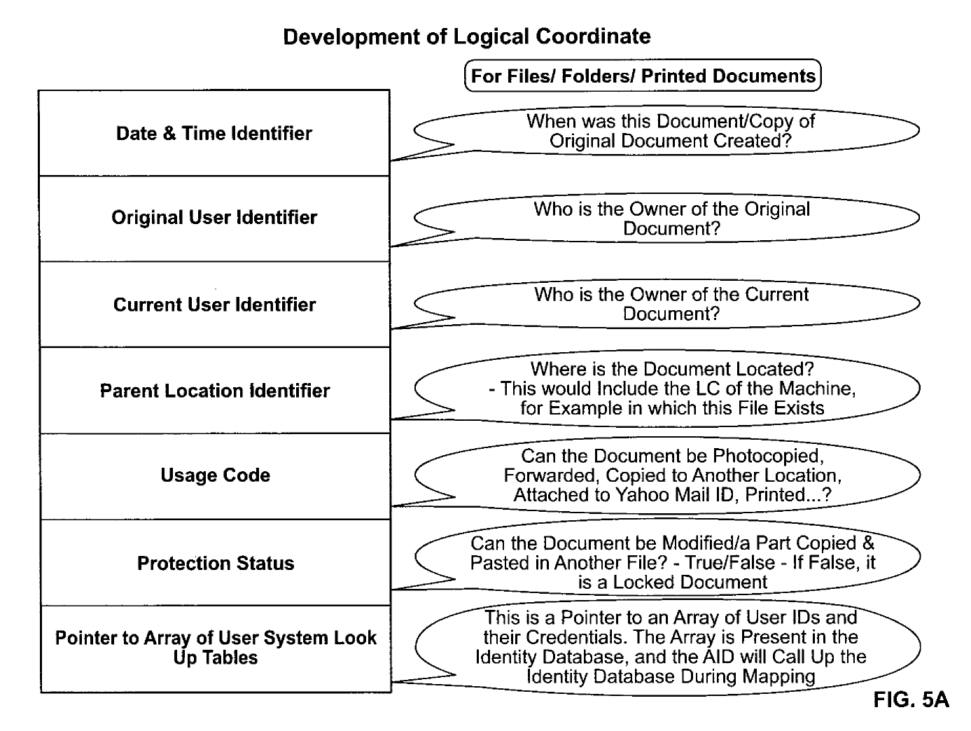

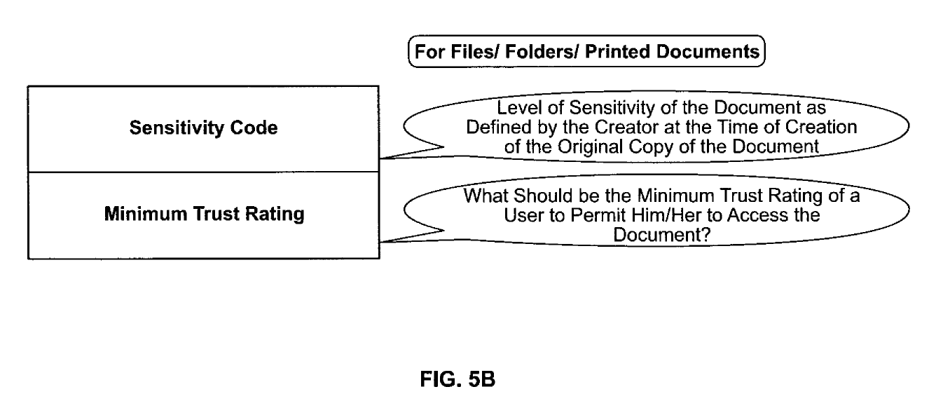

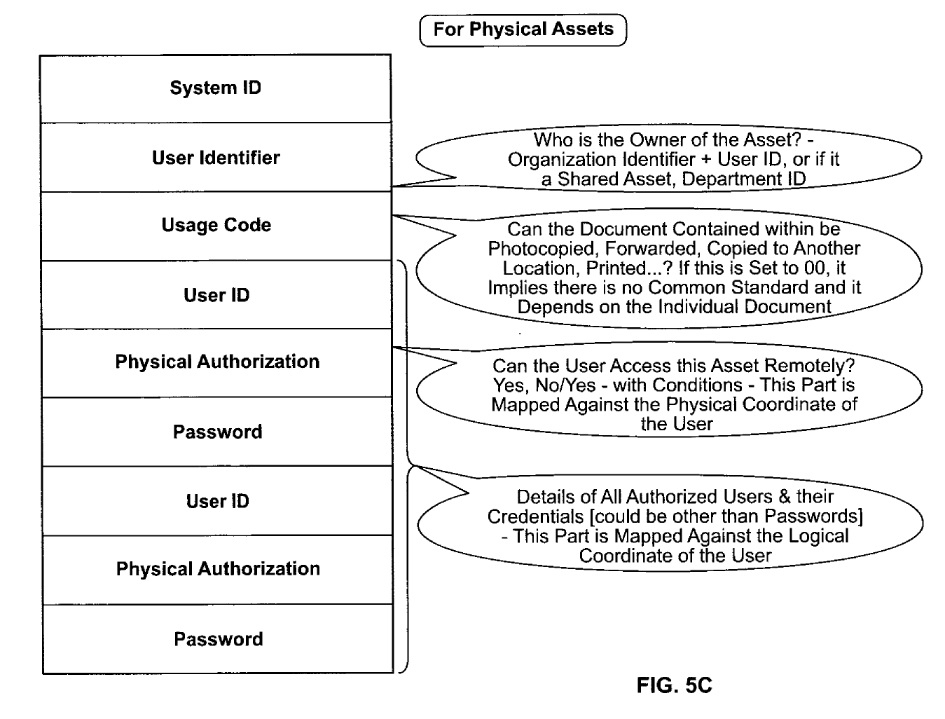

Reference is made to U.S. Patent Application Publication US 2008/0091681 A1 for an example construction of a logical coordinate. This logical coordinate construction is described in detail in this published application with some use case scenarios addressed. FIGS. 5A, 5B, and 5C are adopted from U.S. Patent Application Publication US 2008/0091681 A1 and explain the various example elements that can be used define a logical coordinate.

The mapper 22 may be implemented in accordance with the teachings of U.S. Patent Application Publication US 2008/0091681 A1 which is incorporated herein in its entirety. The mapper 22 understands the geography of the enterprise and understands where the various network elements (network ports, for example) are present. The mapper 22 performs a probabilistic determination estimate of the likelihood of a person being in a certain zone, and uses the results of this estimation to perform the mapping.

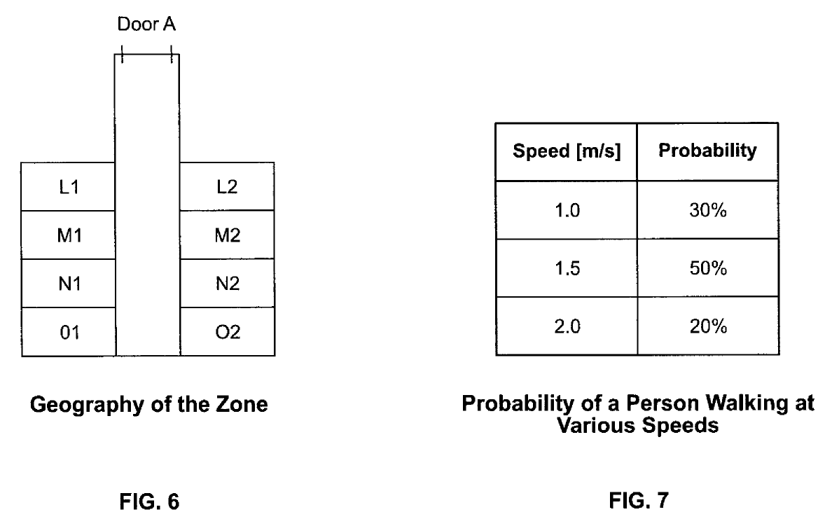

For example, as shown in FIG. 6, there is a zone with 8 rooms—M1, M2, N1, N2, L1, L2, O1 and O2. For the sake of simplicity, the following assumptions may be made: there is only one entrance/exit to this zone—Door A; as shown in FIG. 7, a person can walk only at 3 different speeds, 1 meter per second, 1.5 meters per second, and 2 meters per second, and the probability of the person walking at these 3 different speeds is given in the table of FIG. 7 (in reality, the person is likely to move at any of the intermediate speeds, and Gaussian distribution tables to estimate the relative probability of walking at any of these speeds can be obtained); once a person has entered door A, the probability of that person being present inside any room depends only on the probability of his being able to reach the door of that room (note that the reverse is also applicable, if a person is known to be present in any of the rooms his ability to reach door A is dependent upon the probability of his being able to walk from the door of that particular room to door A in any time interval); and, the user, once having entered the door, goes straight to the room of his concern and does not spend time in the corridor.

With these assumptions, the operation of the mapper 22 can be illustrated. It is assumed that a user swipes his access card at door A at t=0 seconds to gain entry into the zone, and it is further assumed that this particular user's logical coordinate (his login password, for example) is used to access a network resource located in Room O2, which is more than 12 meters away from door A, at t=6 seconds. Now, the mapper 22 calculates that the user requires more than 6 seconds to reach room O2 even at the highest walking speed. It therefore signals this to be an impossible event and hence flags an alarm, revoking access to the user.

The mapper 22 calculates the probabilities of the user being present inside any of the other rooms at t=6 seconds using the various possible options of speeds available to the person: the probability of being present in Room N1 or N2=probability of the user having walked at 2.0 m/s for 6 seconds; the probability of being present in Room M1 or M2=probability of the user having walked at 2.0 m/s for 4.5 seconds or having walked at 1.5 m/s for 6 seconds; and, the probability of being present in Room L1 or L2=probability of the user having walked at 1.0 m/s for 6 seconds or 1.5 m/s for 4.5 seconds or 2.0 m/s for 3 seconds.

It is easily understood that given a certain time interval, there is a higher probability of a user being present in a room closer to door A than one which is further away. The mapper 22 flags any event which has a probability of zero to be a practical impossibility and revokes access (theoretically, a person could reach 12 m in 3 seconds by walking at a speed of 4 m/s which is running but such an event does not happen in organizational context). The Mapper application stores to-scale maps of the layout of the organization and refers to the same for such determinations.

There are various methods of probabilistic determination and the foregoing discussion would enable those skilled in the art to utilize such methods for performing the mapping process. The determination process can increase in the level of complexity to consider several other parameters—for example, the probability of a person stopping inside the corridor, and the method could hence be made more accurate. Irrespective of the determination method used, the mapper 22 considers the probability of the logical coordinate being supplied to gain access to belong to the person, by calculating the probability of the person's being present inside the room.

Now, a common use case leading to organizational data loss is through remote access. Often, organizations deploy a policy of automatic computer locking after a certain time interval during which it has been inactive. This locking is to prevent misuse of information in the physical absence of the user. However, certain other employees often have access to the user's network resources and can log on remotely. Even when the computer is locked, the various applications continue to run, and once a remote access has been obtained, this remote access can be used to retrieve data from those applications.

The concept of a logical coordinate of a person can be extended to include access to other user's applications as well. Whenever a user tries to obtain a remote access to another user's computer, not only the physical and logical coordinates of the former are mapped with those of the computer for the purpose of granting access to the computer, but also the logical coordinates of the person trying to gain access are mapped with each of the running applications. The details of how a logical coordinate is defined and how the credentials of the user are mapped with that of the application follows the same process as described in the U.S. Patent Application Publication US 2008/0091681 A1.

For users having physical access to another user's computer, coordinate mapping for all applications is performed at the time of logging in. Access is granted only for those applications for which the Mapping is true; access is revoked for all other applications.

For example, the secretary of the CEO may have access to his personal mail etc., but may not have authority to open the various attachments. So, whenever the secretary logs on to the CEO's computer, the mapper 22 maps the logical coordinate of the secretary with the logical coordinate of the applications on the computer.

For illustration, if access to Microsoft Outlook is permitted while access to Microsoft Excel is not permitted (this restriction could be used to ensure sanctity of financial information), then, based on how the logical coordinates have been defined earlier, the results of Mapping the secretary's logical coordinates with the Microsoft Outlook application may be “true” but the results of Mapping the secretary's logical coordinates with the Microsoft Excel application may be “false.” Hence, access would be granted in the former case while revoked in the latter case.

To address the possibility of the secretary trying to copy such an attachment (to be opened later on the secretary's own computer where the secretary obviously has access to all applications), the usage code and the protection status while defining the logical coordinate of the original file can be suitably set to prevent such misuse. The details of such definition have been described in U.S. Patent Application Publication US 2008/0091681 A1.

In summary, the mapper 22 matches the physical and logical coordinates of a user with that of an asset whenever the user tries to gain access to the asset. Access is granted only if the coordinates match and is denied otherwise. FIG. 3 illustrates the concept of this mapping.

In FIG. 3 above, the abbreviation PC stands for “Physical Coordinate” and the abbreviation LC stands for “Logical Coordinate”. Whenever the user tries to access a particular asset, the mapper 22 checks if the physical coordinates of the user and the asset match. Matching physical coordinates indicate that the user is present in the same room (or in general, location) as the asset. It is worth noting that physical coordinates of a user who has gained access to the room illegally (say, by tail-gating) will not match with that of the asset. If the physical coordinates do not match because the user is logged in remotely (physical coordinate in this case implies that the user is outside the facility), then, the mapper 22 checks if the user has genuinely gained remote access to the network. If not, logical access is not provided.

The mapper 22 is an additional layer that is implemented along with existing authentication and authorization mechanisms. There might be scenarios where part of the mapper 22 functionality corresponds to the normal logical authentication that is regularly done. In addition, the mapper 22 also ensures that physical co-ordinates match, preventing any unauthorized access.

The identity database 12, the credentials management engine 14, the event interpreter and detector 18, and the mapper 22 of the security system 10 may be centralized. FIG. 8 shows a computer system 40 as one example of an implementation of the security system 10. The computer 40 includes a processor 42, a memory 44, an input device(s) 46, and an output device(s) 48.

The input device(s) 46 can include one or more of the usual computer input devices such as a mouse, a keyboard, etc. However, the input device(s) 46 would also include the sensors 16 and the readers 26.

The output device(s) 48 can include one or more of the usual computer output devices such as a printer, a monitor, etc. However, the output device(s) 48 would also include the alarm monitoring/client viewing workstation 20 and the responder 24.

The input device(s) 46 and output device(s) 48 together further provide an interactive drag and drop environment to the administrator to build rules/policies which control access to physical and IT resources within the organization, based on enterprise and compliance needs. For example, using the input device(s) 46 such as the mouse and the keyboard, the administrator could build rules such as—“Grant logon only when two users are simultaneously present in the room”—this rule is required, for example, when organizations have to comply with HIPAA (Health Insurance Portability and Accountability Act) regulations—it is required to ensure that at least two users are simultaneously present in the room where sensitive patient information is stored on a computer, in order to prevent misuse of patient information (in order to execute such a policy, the mapper 22 would also check for the physical coordinates of a second person, in this case, apart from the usual mapping). The output device(s) 48 provide a viewing environment for the administrator to build such rules (this may be a functionality in the client viewing workstation). A software application that provides such an interactive rule building framework may be installed on the computer 40. The computer 40 may provide the administrator list of parameters/attributes that can be set and updated—to build policies/rules around such as:
Time intervals between successive access (IT and Physical) attempts
Geographic distance between successive access (IT and Physical) attempts
Employee's privileges (Contractor, Regular Employee, and Administrator etc.)
Number of users
Employee Status (active/terminated)
   This list is illustrative only and it would be apparent to those skilled in the art that it could be a powerful tool to dynamically build policies using several different sets of parameters.

The input device(s) 46 and output device(s) 48 together further provide an environment to the administrator to be able to define automated response workflows in case the defined rules/policies are violated. Such workflows should be triggered based on events that deviate from the defined policies. Workflows could also be defined by the administrator to take automated actions based on set parameters (as mentioned in the previous paragraph). For example:
Example 1. If Download to USB memory drive exceeds 2 GB for employee X (defined by policy), then disable employee X's access batch, send security guards to the physical area where employee X is present, disable USB (the implementation of this use case would involve, apart from the mapping functionality to authenticate the user to use the USB drive, an added functionality of being able to measure the amount of data transfer into the drive).
Example 2: Revoke both physical & IT access privileges once the status of the employee/contractor/trainee changes from “active” to “terminated”

The client viewing workstation also allows for a dashboard functionality—wherein the entire risk profile of the organization can be visualized. Since the mapper 22 understands the geography of the enterprise and keeps a record of the physical coordinates (and thus knows the physical locations) of the various users in the memory 44, and also keeps a record of the mappings currently “true” (and thus knows which user is working on which computer), it can provide a risk snapshot of the organization by the table immediately below:

| | | | | |
|---|---|---|---|---|
| Area NI | Area N2 | Area N3 | Area N4 | Area N5 |
| I II III IV | | | Cubicle 114 | |
| | | | Terminated | |
| | | | Employee XYZ | |
| | | | working | |
| Rest Rooms | Area N5 | Training | Area N7 | Area N8 |
| | and N6 | Room | | |

.
.
.

| | | | | |
|---|---|---|---|---|
| Conference | Area S2 | Area S3 | Area S4 | Area S5 |
| Room | | | | |
| Contractor | | | | |
| present | | | | |
| inside: | | | | |
| plugged a | | | | |
| USB drive | | | | |

Area N4 and the Conference Room represent rooms where policy violations have occurred or where the level of threat is high. Area N1, N2, N4, N4, N5, N7, S2, S3, and S4, for example, are area of moderate sensitivity. The Rest Rooms and the Training Room, for example, are considered to be non-sensitive areas.

Such representations permit the administrator/compliance officers to respond to threats/perform their respective functions more effectively. They could also provide a perspective into the risk level of the organizations to the auditors/CXOs of the organization who could delve into the reasons for the current level of risk.

The mapper 22 also allows for building rules linking the category and hence privileges of employees. For example, since the logical coordinate of any user is linked to the user array stored in the identity database 12 as shown in the FIG. 10, the administrator could build a rule such as:
In case physical entry of persons with low authority such as contractors in designated areas that contain unlocked computers or has no authorized person (has the right level of authority) in that room is observed, an alert should be triggered. The administrator should be able to define the policy and the various criteria, if deemed required. (The administrator may define the “level of authority” for various users. The administrator may define the relevant room/area, etc.)
If a person below a certain level of authority (contractor etc.) is detected to be present inside a designated room/area, and is detected to be alone, all the data extracting ports [USB drives, CD drives . . . ] should be disabled.

In the implementation of such a rule, let it be assumed that the contractor (person with a low level of authority) and a regular employee (person with a high level of authority) are present in the room. Let it also be assumed that the regular employee has logged on to the computer and tries to leave the room such as for a cup of coffee. The mapper 22 had already performed a mapping of the user's coordinates to grant the user access to this computer. Since the mapper 22 understands the geography of the enterprise, it also retains in memory the physical coordinate of the contractor when the contractor swipes in. Since all logical/physical coordinates are linked to the user ID, the mapper 22 can refer to the user array table in the identity database 12 in order to check for their respective privileges. Since the regular employee's authority is high and that of the contractor is low, the mapper 22 could, for example, in accordance with the rule set by the administrator, flag a deviation which results in the responder 24 disallowing exit to the regular user from the door (to prevent the contractor being left alone in the room with the computer(s)). This illustration demonstrates how the concept of mapping can be used to create & enforce various policies in an organizational, and in general, societal context. It could have applications in public gatherings, sports & media events, for example, ensuring that no person below a certain level of authority (trust) is left alone in certain areas to be able to perform any mischief.

The memory 44 stores the identity database 12, the credentials management engine 14, and any other programs and/or databases as desired. In addition, the memory 44 can store applications that are appropriate to the security system 10 and/or to other tasks to be run on the computer 40. Also, the memory 44 stores, for example, for every event generated, the new physical and logical coordinates of the user/asset concerned. The mapper 22 can call up the memory 44 or the identity database 12 as needed for the data it needs to perform the mapping.

The processor 42 executes the event interpreter and detector 18, the mapper 22, and the responder 24 of the security system 10. The event interpreter and detector 18, the mapper 22, and the responder 24 may be dedicated parts of the processor 42 or they may be routines executed by the processor 42 and stored in the memory 44.

The computer 40 is coupled over a network 40 to the resources that are to be protected by the system 10. As indicated above, these resources may include devices, data, facilities, etc.

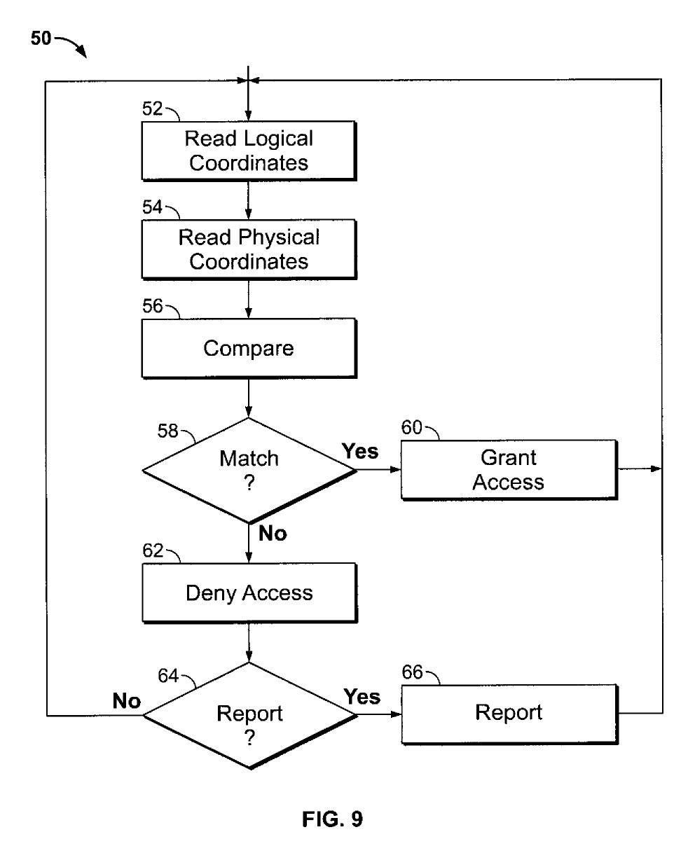

FIG. 9 is a flow chart an application 50 that can be executed by the processor 42 to execute certain aspects of the security system 10. At 52, the logical coordinates of a user and an asset are read. At 54, the physical coordinates of the user and the asset are read. It is not necessary that the logical coordinates be read before the physical coordinates. Instead, it is quite possible and might even be the usual case to read the physical coordinates before the logical coordinates (the user has to enter the office before logging on to the computer).

At 56, the physical and logical coordinates of the user and the asset as appropriate are compared. If the appropriate coordinates favorably compare as determined at 58, the user is granted access to the asset at 60 and flow returns to 52.

If the appropriate coordinates do not favorably compare as determined at 58, the user is denied access to the asset at 62. At 64, a decision is made as to whether the discrepancy between coordinates of the user and the asset is sufficient to generate a report to alarm monitoring/client viewing workstation 20. If so, the report is generated at 66 and flow returns to 52. If the discrepancy between coordinates of the user and the asset is not sufficient to generate a report to alarm monitoring/client viewing workstation 20, flow returns to 52.

Thus, for example, the physical coordinates of the user and the asset are read 54, a probability that the user and the asset are close to one another based on the physical coordinates of the user and the asset as discussed above is determined at 56, and the application 50 decides at 58 whether to permit the user access to the asset based on the probability.

As another example, the logical coordinates of the user and the asset are read at 52, the logical coordinates of the user and the asset are compared at 56, and the application 50 decides at 58 whether to permit the user access to the asset based on the comparison. In general, the application 50 considers all feasible combinations of physical and logical coordinates for comparison at 56.

Modifications of the present invention will occur to those practicing in the art of the present invention. Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A method of providing security comprising:
determining a physical coordinate of a user;
determining a physical coordinate of an asset;
determining a probability that the user and the asset are close to one another based on the physical coordinates of the user and the asset; and,
deciding whether to permit the user access to the asset based on the probability.

2. The method of claim 1 wherein the physical coordinate of the user comprises a location of the user, and wherein the physical coordinate of the asset comprises a location of the asset.

3. The method of claim 2 wherein the physical coordinate of the user comprises:
a facility identity of a facility in which the user is located;
a zone identity of a zone of the facility in which the user is located; and,
a room identity of a room in the zone of the facility in which the user is located.

4. A method providing security comprising:
determining a logical coordinate of a user;
determining a logical coordinate of an asset;
comparing the logical coordinates of the user and the asset; and,
deciding whether to permit the user access to the asset based on the comparison.

5. The method of claim 4 wherein the logical coordinate of the user comprises a credential defining an extent of a right of the user to use the asset, and wherein the logical coordinate of the asset comprises a unique identifier assigned to the asset.

6. The method of claim 5 wherein the credential of the user comprises a password assigned to the user.

7. The method of claim 4 further comprising:
determining a physical coordinate of the user;
determining a physical coordinate of the asset;
determining a probability that the user and the asset are close to one another based on the physical coordinates of the user and the asset; and,
deciding whether to permit the user access to the asset based on the probability.

8. The method of claim 7 wherein the physical coordinate of the user comprises a location of the user, and wherein the physical coordinate of the asset comprises a location of the asset.

9. The method of claim 8 wherein the physical coordinate of the user comprises:
a facility identity of a facility in which the user is located;
a zone identity of a zone of the facility in which the user is located; and,
a room identity of a room in the zone of the facility in which the user is located.

10. The method of claim 4 further comprising:
defining policies based on defined conditions;
mapping the physical and logical coordinates in a manner that enforce the policies; and,
reporting violations of the policies based on the mapping.

11. The method of claim 4 further comprising comparing physical and logical coordinates of more than one user for the purpose of enforcing a policy.

12. The method of claim 4 further comprising:
mapping multiple user coordinates; and,
providing a risk perspective of the organization based on the mapping.

13. A method of providing security comprising:
setting privileges of a user;
changing the privileges of the user;
adding/deleting new/existing users; and,
attributing the changes in the privileges of the user and addition/deletion of users to person who made the changes.

14. A method of providing security comprising:
determining a physical coordinate of a user;
determining a physical coordinate of an asset;
determining a logical coordinate of a user;
determining a logical coordinate of an asset;
comparing the physical and logical coordinates of the user and the asset in various combinations; and,
deciding whether to permit the user access to the asset based on the results of the comparison.

15. The method of claim 14 wherein the physical coordinate of the user comprises a location of the user, and wherein the physical coordinate of the asset comprises a location of the asset.

16. The method of claim 15 wherein the physical coordinate of the user comprises:
a facility identity of a facility in which the user is located;
a zone identity of a zone of the facility in which the user is located; and,
a room identity of a room in the zone of the facility in which the user is located.

17. The method of claim 14 wherein the logical coordinate of the user comprises a credential defining an extent of a right of the user to use the asset, and wherein the logical coordinate of the asset comprises a unique identifier assigned to the asset.

18. The method of claim 17 wherein the credential of the user comprises a password assigned to the user.

19. The method of claim 14 further comprising:
defining policies based on defined conditions;
mapping the physical and logical coordinates in a manner that enforce the policies; and,
reporting violations of the policies based on the mapping.

20. The method of claim 14 further comprising comparing physical and logical coordinates of more than one user for the purpose of enforcing a policy.

21. The method of claim 14 further comprising:
mapping multiple user coordinates; and,
providing a risk perspective of the organization based on the mapping.
